(19) United States
(12) Patent Application Publication
(10) Pub. No.: US 2026/0009663 A1
(43) Pub. Date: Jan. 8, 2026

(54) ELECTROMAGNETIC FLOW METERS, PUMPS, AND METHODS OF OPERATING THE SAME WITH IMPROVED FLOW MEASUREMENT

(71) Applicant: GE-Hitachi Nuclear Energy Americas LLC, Wilmington, NC (US)

(72) Inventors: Nikolas Davis, Tulsa, OK (US); Scott A. Wagner, Grosse Pointe, MI (US); Samuel P. Matylewicz, Newark, DE (US); Nicholas P. Long, Fort Mill, NC (US)

(21) Appl. No.: 18/765,235

(22) Filed: Jul. 6, 2024

(51) Int. Cl. G01F 1/58; H02K 44/06

(52) U.S. Cl. CPC G01F 1/586; G01F 1/582; H02K 44/06

(57) ABSTRACT

Systems and methods for measuring EM field-carrying fluid flow use a difference in magnitude or phase of the field as the fluid flows. The difference indicates with fluid speed, and this relationship can be established beforehand, experimentally, or from the magnetic Reynolds number. Systems take advantage of the EM field, such as that created by a stator coil in an EM pump by detecting that field advected in the pumped fluid downstream. Magnitude or phase difference of the field, as reportable by a voltage in a conductive receiver reflects the flow rate, and thus speed, of the fluid between the initial and detected points. A computer or logic can thus readily output fluid rate, such as from a pump, from any electrical signal generated by the advected field. Systems do not require power, field induction, lengthy straight conduits, co-planar generators and sensors, flow interruptions, or large attachment or surrounding structures.

### BACKGROUND

FIG. 1 is a perspective, cut-away view of a related art electromagnetic flow meter 10 mounted about pipe 1. As seen in FIG. 1, pipe 1 carries a fluid flow 14 of an electrically-conductive fluid, such as ion-bearing water, liquid metal, conductive polymers, or any other flowing conductor. Flow meter 10 is mounted about a straight section of pipe 1 to introduce a magnetic or electric field and sense electric or magnetic forces generated by fluid flow 14 moving through the same. As shown in FIG. 1, an inductive coil 11 is provided with induction current 12, which generates magnetic field 13 in a direction perpendicular to flow 14. The movement of the conductive fluid in flow 14 induces a proportional voltage 17 perpendicular to both flow 14 and field 13. One or more electrodes 15 or other voltage sensing-devices in the plane of voltage 17 can detect a strength of voltage 17 and report it back as a sensor current 16 to a controller or other converter to output for flow rate determination. That is, when the strength of magnetic field 13 is known along with conductive properties of flow 14, voltage 17 may be directly proportional to, and determinative of, a rate of flow 14.

Related art flow meter 10 is useable on a relatively straight section of pipe 1, such that flow 14 passes perpendicular to field 13. Power and sensor connections may be separately connected to meter 10 to permit distinct induction current 12 and sensor current 16 to be provided and received for powering and measuring from meter 10. For example, meter 10 may be places on a straight section of pipe 1 downstream from source of flow 14, such as a pump or reservoir of flow 14. U.S. Pat. No. 9,021,890 to Rogers; U.S. Pat. No. 9,360,355 to Gouwens; U.S. Pat. No. 9,709,429 to Beerling et al.; U.S. Pat. No. 10,670,437 to Brockhaus et al.; and Ser. No. 11,054,201 to Dames et al. all describe flow meters having various configurations of field induction and sensing field generation for flow measurement, and are incorporated by reference herein in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems and methods for measuring flow of electromagnetic field-carrying fluids by measuring a difference in magnitude or phase of that field at two points traversed by the fluid. The difference correlates with fluid speed, which can be determined empirically and/or theoretically. The electromagnetic field may be created by a variety of phenomenon, including by current applied to a stator coil around a flow path of the fluid in an electromagnetic pump, and the difference can be determined by picking up that field as advected downstream by a flow of the fluid by a nearby conductor that converts the advected field to an electrical voltage or current. For example, the relative phase between an input waveform current generating the electromagnetic field in the fluid and the phase in the voltage may directly and continuously vary with speed of the fluid. This relationship may be stored by a computer that can then quickly and accurately output fluid speed from the electrical signal generated in the conductor. No additional power need be applied to the conductor, and no additional interfering structure like a venturi or pilot tube or field like an induced magnetic field from an induction coil need be used by these examples.

Example systems may take advantage of these example methods in several ways. For example, in a flow within a conduit driven by an inductor, like an electromagnetic pump stator, or other inducing phenomenon, the electromagnetic field will be advanced by the flow and changed by the speed of the flow. By picking up the field with a conductive receiver downstream about the conduit, the resulting electricity in the receiver can directly and reliability determine the speed. For example, a computer or signal processing circuit connected to the receiver can determine a magnitude, phase, and/or frequency of the advected field, and compare the same to these initial properties of the field at a known point upstream from the receiver, such as from an input current to an electromagnetic pump coil. From a known relationship between the two determined experimentally or through physical equation, the circuitry can output the flow rate or speed of the fluid of the flow between the points. No additional power or induction is required, and the receiver may be compact, such as coils of high-temperature metal about a pipe or other conduit of any shape. Such flexible metering systems may be used in electromagnetic pumps as an additional pick-up after the stators to determine flow speed output from the pump, requiring no additional power, mounting, or control, or they may be installed on any pipes or channels of any size or even non-straight shape within any distance where an advected electromagnetic field is carried by the fluid.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art electromagnetic flow meter.

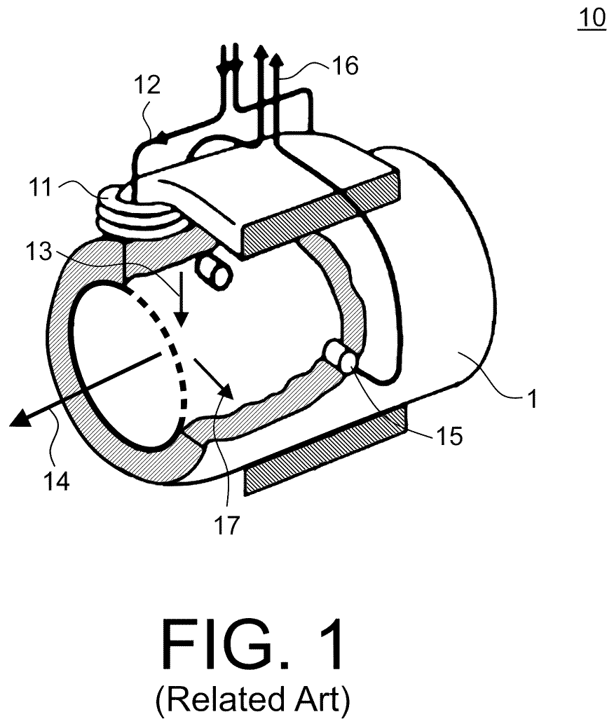

FIG. 2 is a cross-sectional illustration of an example embodiment flow meter in an example embodiment electromagnetic pump.

FIG. 3 is an illustration of an example embodiment flow meter downstream of an inductive component.

FIG. 4 is an example of a relationship between measured flow rates and phase differences between current inputs and advected voltages for three sets of different input current frequencies.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that existing electromagnetic flow meters require strong permanent magnets and/or outside power to generate a current in an inductive coil, to create an impinging magnetic field. This field interferes with fluid flow, and the permanent magnet/power and coil required can be bulky, especially where they must be coplanar to any electrodes picking up the electrical field generated. Because related art devices further need small, straight runs of flow to work, they cannot accommodate tight or curved flow paths. Related art devices are thus difficult to install in compact flow areas or environments sensitive to penetrations, including within electromagnetic pump casings or about high-temperature, physically-challenging coolant pipes. To overcome these newly-recognized problems as well as others, the inventors have developed example embodiments and methods described below to address these and other problems recognized by the inventors with unique solutions enabled by example embodiments.

The present invention is electromagnetic pumps, flow meters, and/or methods of determining flow rates. In contrast to the present invention, the few example embodiments and example methods discussed below illustrate just a subset of the variety of different configurations that can be used as and/or in connection with the present invention.

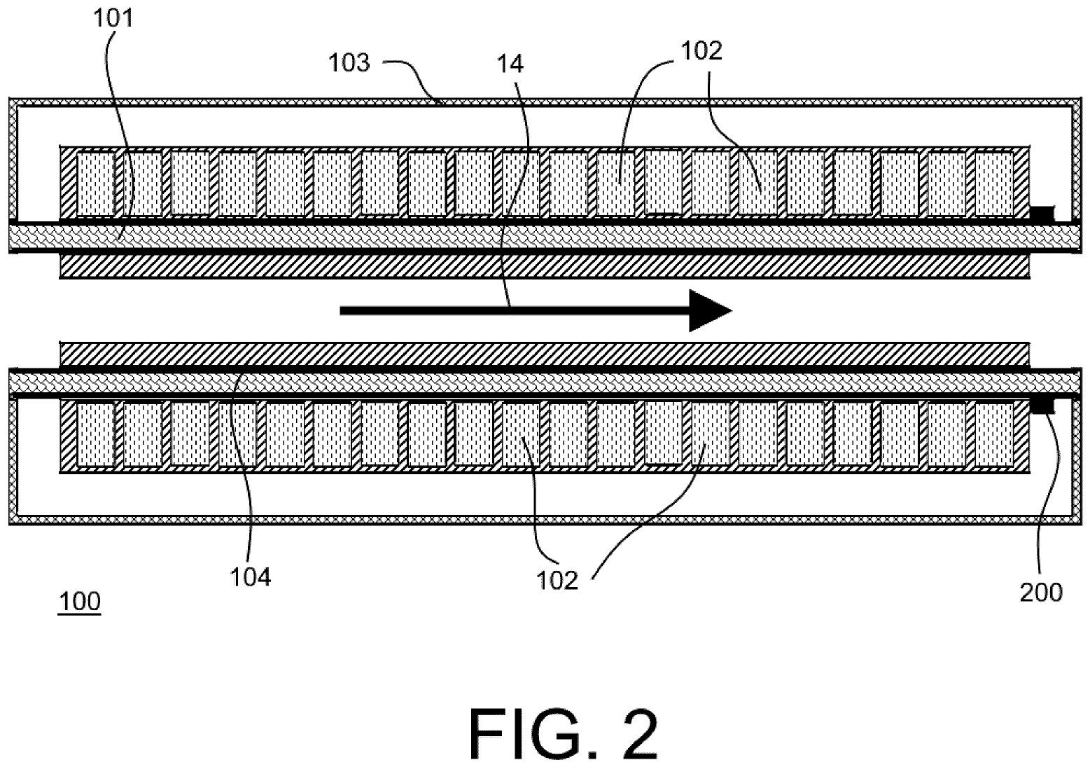

FIG. 2 is an illustration of an example embodiment electromagnetic flow meter 200 useable in connection with an example embodiment electromagnetic pump 100. As seen in FIG. 2, conductive fluid flow 14 moves through flow annulus 101 of pump 100. Several stators or coils 102 may surround annulus 101 and drive flow 14 through induction upon receiving a drive current. Ferrous or otherwise magnetic material 104 may enhance flow 14 under the force of the induced magnetic field. Pump case 103 may contain the electronics and insulation in a package with the remainder of the internals of example embodiment pump 100. Example embodiment electromagnetic pump 100 may otherwise have any flow shape and case size as existing electromagnetic pumps, and/or be useable in place of any electromagnetic pump, including those found in US Pat Pub 2020/0403555 to Mills; US Pat Pub 2011/0280737 to Sarkinen et al.; CA Pat Pub 3187103 to Corbin; US Pat Pub 2003/0102352 to Aizawa et al.; and US Pat Pub 2022/0372973 to Dupeu et al., and U.S. patent application Ser. No. 18/428,629 filed Jan. 31, 2024 by Meek et al. for ELECTROMAGNETIC PUMPS AND METHODS OF OPERATING THE SAME WITH IMPROVED COOLING, all incorporated by reference herein in their entireties.

Example embodiment electromagnetic flow meter 200 includes a non-powered pickup coil or coils, such as a winding of conductive wire around flow annulus 101. Coils of flow meter 200 may pass around annulus 101 any number of times and may be insulated metal wire or any other conductor. Other shapes and lengths of the coil of flow meter 200 can be used, directly on or at distance from the surface of any flow conduit, so long as the coil can pick up electromagnetic fields passing through it. As seen in FIG. 2, example embodiment electromagnetic flow meter 200 may be inside pump case 103 after a final stator coil 102. Electromagnetic flow meter 200 may be used outside pump case 103, on another flow conduit, within a distance downstream to still pick up advected electromagnetic fields within flow 14. In this way, example embodiment electromagnetic flow meter 200 is useable in or with an electromagnetic pump, or any other component or phenomenon imparting an advected field into the fluid flow.

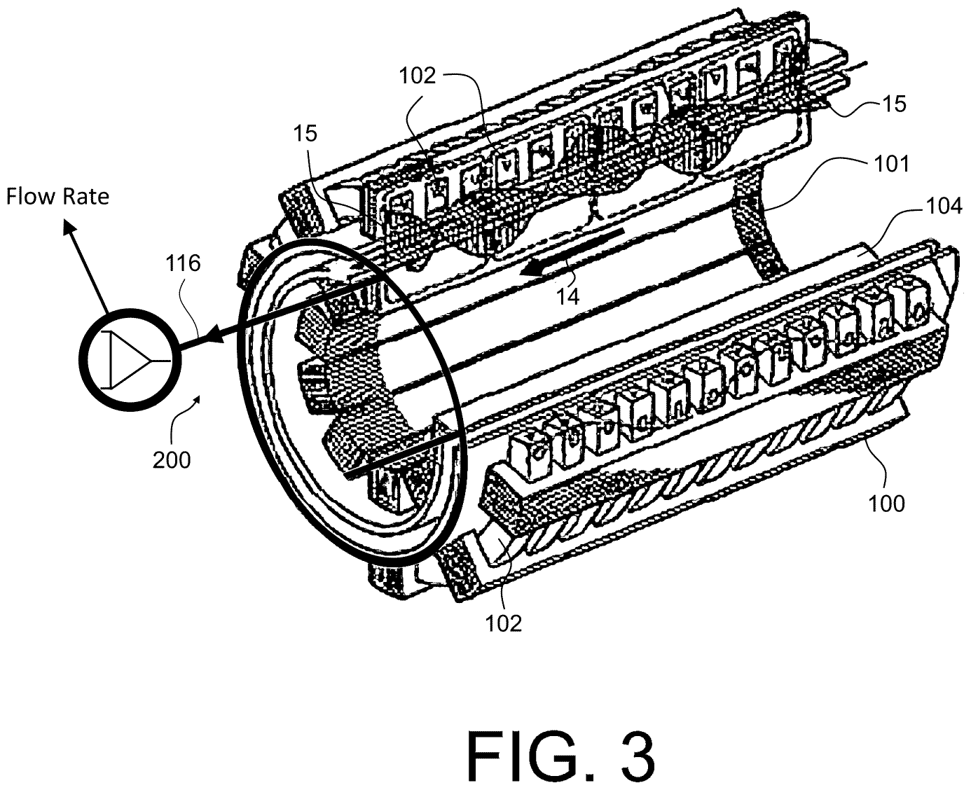

Conductive fluid flow 14 advects the electromagnetic fields developed by the induction of coils 102 in pump 100. For example, as shown in FIG. 3, flow 14 may carry alternating electromagnetic field 15 caused by stator coils 102 past a final coil 102 and even out of pump 100 entirely. The magnitude of advected field 15 at a given position downstream is proportional to the velocity of flow 14. As advected field 15 reaches and interacts with the conductive loop of flow meter 200, it induces a voltage and resultant current 116 in the conductive loop of flow meter 200 proportional to advected field 15 at the loop. Voltage and/or current 116 may be output for processing or direct reporting as a rate of flow 14 from example embodiment electromagnetic flow meter 200. Example methods of such processing or further use of voltage or current 116 to determine volumetric flow rate and flow speed are discussed below.

Example embodiment electromagnetic flow meter 200 may be installed at any time on a conduit whose internal flow is desired to be measured, within any sensible distance of an advected field. For example, meter 200 may be manufactured with pump 100 and provided as a flow rate output or controller of the same; such pump 100 may be installed at any location or purpose needing electromagnetic pumping. Or, for example, meter 200 may be retrofitted onto existing pipes, channels, flow measurement tubes, etc. or in existing pumps by positioning its coil to surround a flow path of the same. This could be as simple as running a wire around an outer perimeter of the flow path seating the wire by friction without the need for special bracketing, screws, or welds, or could use loops of insulated wire in set insulation at some distance from the outer surface of the flow path to be sensed, for example.

Example embodiment electromagnetic flow meter 200 may output through a single and/or existing pump control output to reduce the number of wires and penetrations necessary about the flow conduit. Similarly, meter 200 may not require any power source or induce any significant magnetic or electrical field in the flow path or its surroundings, and so may be used in numerous small spaces without running additional power lines, control connections, or other interference with flow path externals or internals.

Example embodiment flow meter 200 may include or be useable with circuitry, including hard-wired logic or a processor-driven programmed computer, or calculation to accurately determine a flow rate from its output voltage and/or current 116. The logic may include circuit elements, and the programming may include the actions, for executing empirical and/or theoretical conversion of voltage or current to flow rates or speeds. For example, the flow rate may be empirically determined by associating a magnitude, frequency, or phase angle of reported current and/or voltage 116 with known flow rates, stator coil input current, and/or advected electromagnetic fields at a set position of the coil. A phase angle and/or frequency shift between a reported voltage wave and input current wave may be particularly reliable, as it may not significantly vary with stator coil input current. Such experimental determination may be performed at any time, such as at pump manufacture or installation, or as part of a recalibration after installation, where known flow rates or speeds are set in association with, such as by a function or interpolation-capable table, magnitudes and/or phase angle of the sensed voltage or current.

Similarly, the flow rate may be determined and/or verified theoretically or algorithmically. Electromagnetic fields, including magnitudes, frequencies, and relative phases of the same measurable by flow meters 200, are advected by moving conductive fluids according to their magnetic Reynolds number, which is a relatively stable relationship between the fluid's mass flow rate and magnetic diffusivity, a set property based on the fluid's chemical makeup. The initial electromagnetic field, which is determinable from the stator current inputs, reduces in magnitude over flow distance in proportion to the flow's magnetic Reynolds number, while its frequency remains static. Thus, knowing the distance of the coil from the initial electromagnetic field, the magnitude and/or phase of the initial electromagnetic field, the hydraulic diameter of the conduit, and/or the fluid's magnetic diffusivity allows determination of the flow speed of the fluid from the sensed current and/or voltage 116 from the advected electromagnetic field.

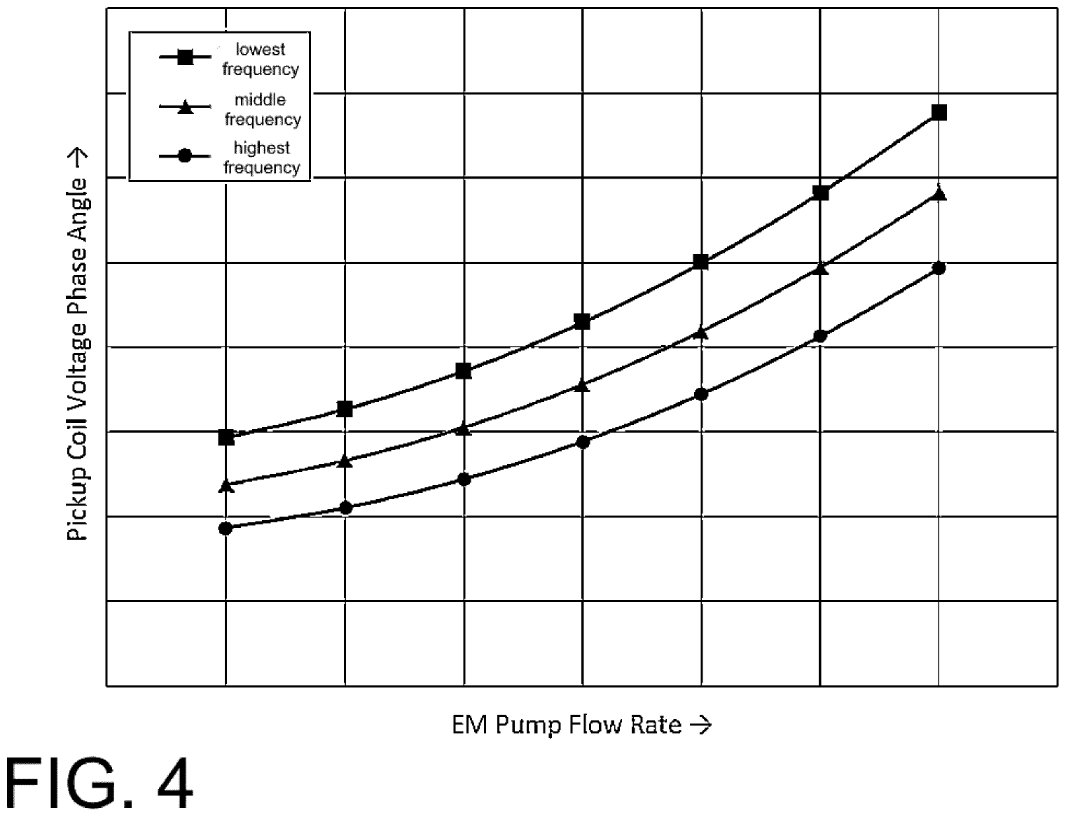

The inventors verified the above determinability of flow rate using an example embodiment flow meter having several turns of copper coil about a flow conduit of known size at a known distance from the initial input stator coil input current of an electromagnetic pump on the conduit. The reported voltage magnitude and phase angle from the coil reliably and determinatively followed the separately-measured electromagnetic pump flow rate. While the relationships between voltage magnitude and flow rate changed with different pump current input magnitude and frequencies, they were still determinable, with a continuous relationship for a set input magnitude and frequency. For example, FIG. 4 illustrates an example of a determined relationship between flow rate and phase difference between input current and advected voltages, for three different input current frequencies. This, or any other relationship, is useable for flow meter programming or other determination of flow rate from output signals, for a given set of operating conditions. As seen in FIG. 4, phase angle in particular showed congruent relationships for flow rate with different current input frequencies. As such, the use of phase angle may allow selection of a single set of flow rates regardless of input current magnitude changes and requiring only value adjustment for input current frequency changes.

The above example methods thus allow higher accuracy in determination of fluid flow rates and speeds through a conduit, with minimal complexity or recalibration required. Because example embodiment flow meters and methods can be relatively small and flexible, with no additional powering or change to a flow conduit or interruption of a flow therein, they can be installed and used in nearly any location or with any flow path carrying an advected field that can be sensed. The pickup conductor does not have to be coplanar with any induced magnetic field, which itself is not even required, like in the related art devices. No lengthy, perfectly straight section of piping or flow path intrusion is necessary, and even very large channels or pipes that might require large amounts of power to monitor with related art inductive electromagnetic flow monitors can be measured with example embodiment flow meters and methods without additional power, induction coils, or surrounding electrodes. Example embodiment flow meters are thus usable in highly-compact and inaccessible areas, such as about high-temperature industrial pipes or in penetration-sensitive liquid metal reactor electromagnetic pumps.

Example embodiment pumps 100 and electromagnetic flow meters 200 may use any materials compatible with an operating nuclear reactor environment, including radiation-resilient materials that maintain their physical characteristics when exposed to high-temperature fluids, liquid metals, and radiation without substantially changing in physical properties, such as becoming substantially radioactive, melting, brittling, retaining/adsorbing radioactive particulates, etc. For example, ceramics or metals such as stainless steels and iron alloys, zirconium alloys, etc., including austenitic stainless steels 304 or 316, XM-19, Alloy 600, etc., are useable for various pump and flow meter components including those that may touch liquid coolant for primary coolant paths containing the same at several hundred degrees Celsius. Conductive, high-temperature materials, including insulated copper, nickel, and/or nickel-plated copper are similarly useable for coil and wire pickup loops in example embodiments. Less-conductive materials may be used, with an increased number of loops or turns to produce more voltage and pick up in the coil and pickup loops. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

Some example embodiments and methods thus being described, it will be appreciated by one skilled in the art that examples may be varied through routine experimentation and without further inventive activity. For example, although some types of control rod drives found in commercial nuclear power plants are the target of some example embodiments and methods, it is understood that other control elements are useable with example embodiments and methods. Variations are not to be regarded as departure from the spirit and scope of the example embodiments, and all such modifications as would be obvious to one skilled in the art are intended to be included within the scope of the following claims.

1. A flow meter for use with a conductive fluid, the meter comprising:
a conduit shaped to carry a flow of the conductive fluid;
an inductor configured to cause an electromagnetic field to be carried by the flow; and
a conductive wire around the conduit, wherein the conductive wire is not in contact with an electrical power source to drive current or voltage in the conductive wire, and wherein the conductive wire is configured to convert the electromagnetic field from the flow to a voltage or current in the wire based on a speed of the flow.

2. The flow meter of claim 1, wherein the conductive wire forms a coil with multiple loops each completely around an outer perimeter of the conduit, and wherein the flow passes through the loops.

3. The flow meter of claim 2, wherein the conductive wire includes copper and there are ten or more of the multiple loops.

4. The flow meter of claim 1, wherein the inductor is a stator coil surrounding the conduit.

5. The flow meter of claim 1, wherein the stator coil is one of a plurality of coils in an electromagnetic pump.

6. The flow meter of claim 1, wherein the conductive wire is spaced from the inductor in a direction along the conduit downstream of the flow in the conduit.

7. The flow meter of claim 6, wherein there is no electrically-powered element beyond the inductor in the direction in the flow meter.

8. The flow meter of claim 7, wherein the inductor includes stator coils on an electromagnetic pump, and wherein the conductive wire is spaced in the direction from a final stator coil in the direction within a pump casing of the electromagnetic pump.

9. The flow meter of claim 1, further comprising:
circuitry in contact with the conductive wire and configured to receive the current or voltage from the conductive wire, wherein the circuitry is configured to convert the current or voltage to the speed of the flow and output the speed.

10. The flow meter of claim 9, wherein the circuitry is configured to convert the current or voltage to the speed based on an empirical relationship between current or voltage and the speed stored with the circuitry.

11. The flow meter of claim 10, wherein the relationship is between the speed and a phase of the voltage relative to a phase on an input current to the inductor.

12. An electromagnetic pump for a conductive fluid, the pump comprising:
a channel configured to receive the fluid and expel the fluid from the pump;
a stator coil around the primary channel and configured to develop a magnetic field in the primary channel from an induction current passed through the stator coil; and
a conductive wire around the channel, wherein the conductive wire is not in contact with an electrical power source to drive current or voltage in the conductive wire, and wherein the conductive wire is configured to convert the electromagnetic field from the fluid to a voltage or current in the wire based on a flow rate of the fluid.

13. The electromagnetic pump of claim 12, wherein there is no stator coil between the conductive wire and an end of the pump.

14. The electromagnetic pump of claim 12, wherein the conductive wire is an insulated metal wire wrapped several times on an outer perimeter of the channel.

15. The pump of claim 12, further comprising:
circuitry in contact with the conductive wire and configured to receive the current or voltage from the conductive wire, wherein the circuitry is configured to convert the current or voltage to a speed of the flow and output the speed.

16. The pump of claim 15, wherein the circuitry is configured to convert the current or voltage to the speed based on an empirical relationship between current or voltage and the speed stored with the circuitry.

17. The pump of claim 16, wherein the relationship is between the speed and a phase of the voltage relative to a phase on an input current to the inductor.

18. A method of determining flow of a conductive fluid through a conduit, the method comprising:
receiving a voltage from a conductive wire generated by an electromagnetic field advected by the fluid from an initial point to the conductive wire, wherein no other voltage is applied to the conductive wire in the method; and
convert the voltage to a speed of the flow based on at least one of a magnitude of the voltage and a phase of the voltage relative to the electromagnetic field at the initial point.

19. The method of claim 18, wherein the initial point is a final stator coil in an electromagnetic pump generating the electromagnetic field in the fluid from a current applied to the final stator coil.

20. The method of claim 18, wherein converting includes determining the speed from an empirical relationship between the speed and a difference in the phase of the voltage and a phase of an input current generating the electromagnetic field.
